(19) United States
(12) Patent Application Publication
(10) Pub. No.: US 2023/0206055 A1
(43) Pub. Date: Jun. 29, 2023

(54) GENERATING SYNTHETIC TRAINING DATA FOR PERCEPTION MACHINE LEARNING MODELS USING DATA GENERATORS

(71) Applicant: VOLKSWAGEN AKTIENGESELLSCHAFT, Wolfsburg (DE)

(72) Inventors: Mikhail Tetelman, Los Gatos, CA (US); Elnaz Vahedforough, San Jose, CA (US); Jens Langenberg, Redwood City, CA (US)

(21) Appl. No.: 17/564,002

(22) Filed: Dec. 28, 2021

(51) Int. Cl. G06N 3/08; G06N 3/04; G06K 9/62

(52) U.S. Cl. CPC G06N 3/08; G06N 3/0454; G06K 9/6262

(57) ABSTRACT

A method is provided. The method includes generating a set of candidate training data based on a training data generator. The method also includes training a first machine learning model based on the set of candidate training data. The first machine learning model generates a set of inferences during the training based on the set of candidate training data. The method further includes determining a set of importance factors based on the set of inferences and a second machine learning model. The method further includes updating the training data generator based on one or more distributions of properties determined based on the set of importance factors.

### TECHNICAL FIELD

Aspects of the present disclosure relate to machine learning models, and more particularly, to generating training data and training machine learning models.

### BACKGROUND

As devices become more complex and as more devices operate autonomously (e.g., autonomous vehicles (AVs)), machine learning (ML) models, artificial intelligence (AI) models, etc., are often used to control the operation of these complex and/or autonomous devices. Developing these models may be an expensive and time consuming process. It may be difficult to gather training data and to clean/process the training data. It may also be difficult to obtain training data to be used to train a model. In addition, many of the processes or workflows for developing these models is manual (e.g., manually performed by a data scientist/engineer).

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example system architecture, in accordance with one or more embodiments of the present disclosure.

FIG. 2 is a diagram illustrating an example training data module, in accordance with one or more embodiments of the present disclosure.

FIG. 3 is a block diagram that illustrates an example process for generating training data, in accordance with one or more embodiments of the present disclosure.

FIG. 4 is a diagram illustrating example graphs, in accordance with one or more embodiments of the present disclosure.

FIG. 5 is a flow diagram of a process for generating training data, in accordance with one or more embodiments of the present disclosure.

FIG. 6 is a block diagram that illustrates an example vehicle, in accordance with one or more embodiments of the present disclosure.

FIG. 7 is a block diagram of an example computing device that may perform one or more of the operations described herein, in accordance with some embodiments of the present disclosure.

### DETAILED DESCRIPTION

Developing machine learning models (e.g., artificial intelligence (AI) models) for autonomous functions are an increasingly time-consuming and difficult task. Users (e.g., data scientists and/or data engineers) may perform various functions, tasks, etc., when developing the machine learning models. The user may also manage the sensor data that is received from various vehicles (e.g., a fleet of vehicles). These tasks are often manually performed which is time consuming. In addition, these tasks are also prone to error because they are manually done (e.g., users may forget a task or perform a task differently).

Obtaining training data is often a time consuming, manual, and/or difficult task when developing machine learning models. The training data is a set of data which may be used to train, configure, set weights, etc., of a machine learning model. It is often difficult to obtain new or additional training data. Sensor data (e.g., videos, images, CAN data, etc.) can be difficult to obtain and may need to be manually processed/analyzed by a user. However, having a variety of training data may allow machine learning models to be better trained and/or to be more generalized. Thus, it is useful to generate new training data more quickly and/or efficiently.

A data science platform may help address these issues when training and/or developing machine learning models. In one embodiment, a data science system provides an end-to-end platform that supports ingesting the data, view/browsing the data, visualizing the data, selecting different sets of data, processing and/or augmenting the data, provisioning of computational and storage resources, and testing machine learning models. The data science system supports multiple workflows or processes within a single ecosystem/platform which allows users to transition between different phases of the development cycle more easily. The data science system also automates various tasks such as generating training data (such as synthetic training data generated using a simulated environment) and determining whether the training data improves the operation of machine learning models. The simulated environment may be used to generate training data that simulates a problem domain (e.g., scenarios, conditions, etc., that may be encountered by a vehicle).

Although data generators, such as generative adversarial networks (GANs) or variational autoencoders (VAEs), may be used to generate training data (e.g., synthetic training data), the properties of the generated training data may not match the properties of the data that may be provided to a machine learning model when the machine learning model is in operation. For example, the generated training data may not be a good match for real-world situations/data.

The examples, implementations, and/or embodiments described herein may be used to generate training data that is able to match (or get within a threshold) of the properties of real world data or scenarios/situations. This allows a large amount of training data to be generated by the data generators and to be used to train machine learning models. Adding synthetic training data (which may also be referred to as synthetic training data) to the training process may improve the performance of machine learning models (e.g., perception models) under various conditions. This may help improve the quality of the machine learning models that are developed and/or may decrease the amount of time to develop the machine learning models.

Although the present disclosure may refer to machine learning models (e.g., neural networks, generative adversarial networks (GANs), variational autoencoders (VAEs)), the examples, implementations, aspects, and/or embodiments described herein may be used with other types of machine learning or artificial intelligence systems/architectures. Examples of machine learning models may be driver assistant models (e.g., a ML/AI model that may assist a driver of a vehicle with the operation of the vehicle), semi-autonomous vehicle models (e.g., a ML/AI model that may partially automate one or more functions/operations of a vehicle), a perception model such as a ML/AI model that is used to identify or recognize pedestrians, vehicles, etc.), etc.

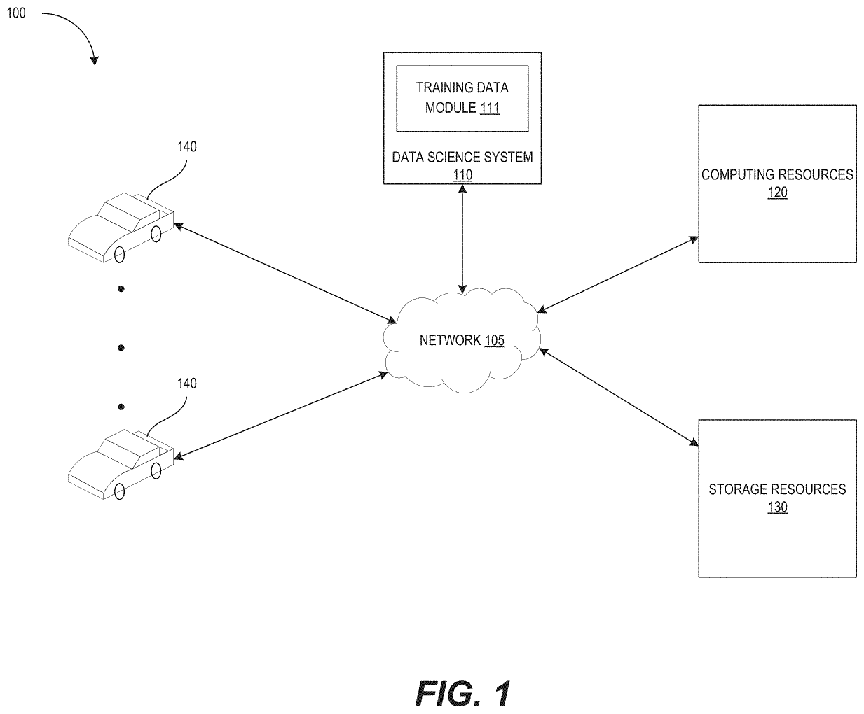

FIG. 1 is a block diagram that illustrates an example system architecture 100, in accordance with some embodiments of the present disclosure. The system architecture 100 includes a data science system 110, computing resources 120, storage resources 130, and vehicles 140. One or more network may interconnect the vehicles 140, the data science system 110, the computing resources 120, and/or the storage resources 130. A network may be a public network (e.g., the internet), a private network (e.g., a local area network (LAN) or wide area network (WAN)), or a combination thereof. In one embodiment, network may include a wired or a wireless infrastructure, which may be provided by one or more wireless communications systems, such as a wireless fidelity (Wi-Fi) hotspot connected with the network, a cellular system, and/or a wireless carrier system that can be implemented using various data processing equipment, communication towers (e.g. cell towers), etc. The network may carry communications (e.g., data, message, packets, frames, etc.) between the vehicles 140, the data science system 110, the computing resources 120 and/or the storage resources 130.

The vehicles 140 may be commercial vehicles, test vehicles, and/or may be autonomous vehicles (AVs). In one embodiment, the vehicles 140 may be a fleet of vehicles that are used to collect, capture, gather, compile, etc., sensor data and/or other data that may be used to develop, improve, refine, or enhance machine learning models. Machine learning models may be models that may be used to manage and/or control the operation of a vehicle. Each of the vehicles 140 may include various sensors that may generate data (e.g., sensor data) as the respective vehicle operates (e.g., drives, moves around, or is otherwise on). Examples of sensors may include, but are not limited to, tire pressure sensors, steering sensors (e.g., to determine the positions/angles of one or more wheels), a compass, temperature sensors, a global positioning system (GPS) receiver/sensor, a light detection and ranging (LIDAR) device/sensor, an ultrasonic device/sensor, a camera (e.g., a video camera), a radar device/sensor, etc. The sensors of the vehicles 140 may generate sensor data such as video data, image data, GPS data, LIDAR data, time series data, etc. Each of the vehicles 140 by way of its sensors may generate gigabytes (e.g., tens, hundreds, thousands, etc., of gigabytes) of data per hour of operation.

The computing resources 120 may include computing devices which may include hardware such as processing devices (e.g., processors, central processing units (CPUs), processing cores, graphics processing units (GPUS)), memory (e.g., random access memory (RAM), storage devices (e.g., hard-disk drive (HDD), solid-state drive (SSD), etc.), and other hardware devices (e.g., sound card, video card, etc.). The computing devices may comprise any suitable type of computing device or machine that has a programmable processor including, for example, server computers, desktop computers, rackmount servers, etc. In some examples, the computing devices may include a single machine or may include multiple interconnected machines (e.g., multiple servers configured in a cluster, cloud computing resources, etc.).

The computing resources 120 may also include virtual environments. In one embodiment, a virtual environment may be a virtual machine (VM) that may execute on a hypervisor which executes on top of the OS for a computing device. The hypervisor may also be referred to as a virtual machine monitor (VMM). A VM may be a software implementation of a machine (e.g., a software implementation of a computing device) that includes its own operating system (referred to as a guest OS) and executes application programs, applications, software. The hypervisor may be a component of an OS for a computing device, may run on top of the OS for a computing device, or may run directly on host hardware without the use of an OS. The hypervisor may manage system resources, including access to hardware devices such as physical processing devices (e.g., processors, CPUs, etc.), physical memory (e.g., RAM), storage device (e.g., HDDs, SSDs), and/or other devices (e.g., sound cards, video cards, etc.). The hypervisor may also emulate the hardware (or other physical resources) which may be used by the VMs to execute software/applications. The hypervisor may present other software (i.e., “guest” software) the abstraction of one or more virtual machines (VMs) that provide the same or different abstractions to various guest software (e.g., guest operating system, guest applications). A VM may execute guest software that uses an underlying emulation of the physical resources (e.g., virtual processors and guest memory).

In another embodiment, a virtual environment may be a container that may execute on a container engine which executes on top of the OS for a computing device, as discussed in more detail below. A container may be an isolated set of resources allocated to executing an application, software, and/or process independent from other applications, software, and/or processes. The host OS (e.g., an OS of the computing device) may use namespaces to isolate the resources of the containers from each other. A container may also be a virtualized object similar to virtual machines. However, a container may not implement separate guest OS (like a VM). The container may share the kernel, libraries, and binaries of the host OS with other containers that are executing on the computing device. The container engine may allow different containers to share the host OS (e.g., the OS kernel, binaries, libraries, etc.) of a computing device. The container engine may also facilitate interactions between the container and the resources of the computing device. The container engine may also be used to create, remove, and manage containers.

The storage resources 130 may include various different types of storage devices, such as hard disk drives (HDDs), solid state drives (SSD), hybrid drives, storage area networks, storage arrays, etc. The storage resources 130 may also include cloud storage resources or platforms which allow for dynamic scaling of storage space.

Although the computing resources 120 and the storage resources 130 are illustrated separate from the data science system 110, one or more of the computing resources 120 and the storage resources 130 may be part of the data science system 110 in other embodiments. For example, the data science system 110 may include both the computing resources 120 and the storage resources 130.

In one embodiment, the data science system 110 may be an application and data-source agnostic system. For example, the data science system 110 may be able to work with a multitude of different applications, services, etc., and may be able to ingest data from various different sources of data (e.g., ingest multiple types/formats of data from multiple types and/or brands of sensors). The data science system 110 may provide a cloud-based infrastructure (e.g., computing resources 120 and/or storage resources 130) that may be tailored/customized for the development of machine learning models (e.g., neural networks, statistical models, rule-based models, etc.). The data science system 110 may support the various workflows, processes, operations, actions, tasks, etc., in the development cycle for machine learning models. The development cycle for a machine learning model may be referred to as a loop, a development loop, a big loop, a development process, etc. The development cycle may include the ingestion of data from the vehicles 140. The data may be selected, processed, cleaned, analyzed, annotated, visualized (e.g., viewed). Computational resources 120 and storage resources 130 may be allocated to develop machine learning models using the data and/or to store modifications to the data. The machine learning models may be deployed in the vehicles for testing and additional data may be collected. Other models (e.g., driver assistant models, semi-autonomous vehicle models, perception models, etc.), may also be deployed in the vehicles for testing. The additional data may be ingested by the data science system 110 and may be used to develop further machine learning models or update/improve existing machine learning models, restarting the development cycle.

In one embodiment, data (e.g., sensor data such as CAN data, images, videos, GPS data, LIDAR data, speed, acceleration, etc.) may be received, collected, ingested, etc., from vehicles 140 (e.g., a fleet of vehicles). The data may be processed, cleaned, formatted, scrubbed, massaged, for further feature labelling, annotation, extraction, manipulation, and/or processing. Users (e.g., data scientists and/or data engineers) may be use the data science system 110 to explore the data (e.g., using a data explorer or data visualizer to search for certain types of data, metadata, annotations, etc.) and to create, test, update, and/or modify various machine learning models.

In one embodiment, the data science system 110 may enable end-to-end development and/or testing of AV models and/or other AV functions. The data science system 110 may streamline, simplify, and/or automate (e.g., fully automate or at least partially automate) various tasks related to the development and/or testing of machine learning models. For example, the data science system 110 may streamline and/or automate the generation of training data, and training machine learning models using the generated training data. The data science system 110 may allow for a faster and/or more efficient development cycle.

In one embodiment, the data science system 110 may manage the allocation and/or use of computing resources 120 (e.g., computing clusters, server computers, VMs, containers, etc.). The computing resources 120 may be used for data transformation, feature extraction, development, generating training data, and testing of machine learning models, etc. The computing resources 120 may use various cloud service platforms (e.g., cloud computing resources). The data science system 110 may also manage the allocation and/or use of storage resources 130. The storage resources 130 may store training data, machine learning models, and/or any other data used during the development and/or testing of machine learning models.

In one embodiment, the training data module 111 may use a training data generator (e.g., a GAN, a VAE, etc.) to generate candidate training data that is used to train various machine learning models (e.g., autonomous vehicle models, perception models, object detection models, neural networks, etc.). The training data module 111 may train a machine learning model using the candidate training data. The training data module 111 may identify importance factors (discussed in more detail below) for the candidate training data as the machine learning model is being trained. The training data module 111 may also determine distributions of properties (e.g., property distributions, which are discussed in more detail below) for the candidate training data and for a set of validation data. If the distribution of properties for the candidate training data is not within a threshold of the distribution of properties for the validation data, the training data module 111 may update the training data generator, generate new candidate training data and repeat the above-operations. If the distribution of properties for the candidate training data is within a threshold of the distribution of properties for the validation data, the training data module 111 may finalize the data generation module (e.g., may finalize weights or parameters).

In some embodiments, machine learning models may be trained using the variety of training data generated by the training data module 111 (e.g., generated by the data generation module). The use of varied training data may help prevent the overfitting of the machine learning models (e.g., perception models) to known, realistic objects and allow the machine learning models to generalize to broader scenarios. Also generation of the training data and scenarios may be more cost efficient when compared to using realistic or hi-fidelity simulation models of realistic scenarios. The embodiments/examples may allow the training data module 111 to identify more important data/samples (e.g., training data) that will have a larger effect on improving a machine learning models (e.g., a perception model). This technique may also allow a larger amount of training data to be generated more quickly and/or automatically.

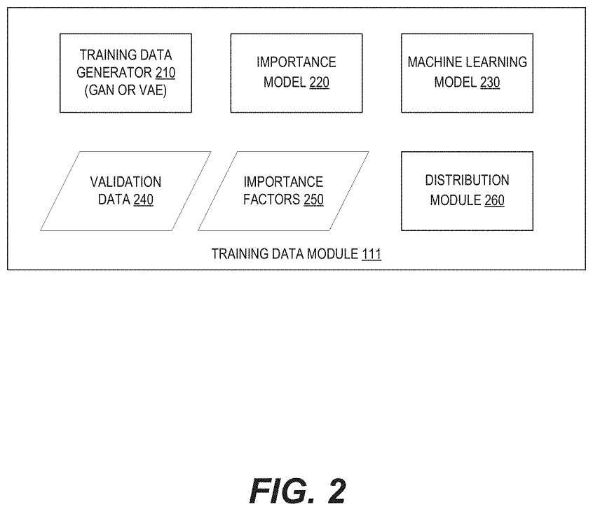

FIG. 2 is a block diagram that illustrates an example training data module 111, in accordance with one or more embodiments of the present disclosure. The training data module 111 includes a training data generator 210, an importance model 220, a machine learning model 230, distribution module 260, validation data 240 (e.g., a set of validation data), and importance factors 250. Some or all of the modules, components, systems, engines, etc., illustrated in FIG. 2 may be implemented in software, hardware, firmware, or a combination thereof.

In one embodiment, the validation data 240 may be data that may be used to initially evaluate the performance of a machine learning model, such as machine learning model 230. If the machine learning model 230 is able to generate correct output/inferences for the validation data 240, then the machine learning model 230 may be tested using a separate set of test data (e.g., may go through final testing). The validation data 240 may be referred to as reference data. Although the present disclosure may refer to validation data, other types of data that may be used.

In one embodiment, the training data module 111 may be part of a data science system (e.g., data science system 110 illustrated in FIG. 1). As discussed above, the data science system may allow users to generate training data and to develop (e.g., code), refine, modify, train, and/or machine learning models (e.g., perception models, driver assistance models, AV models, neural networks, object detection, segmentation, etc.). For example, the data science system may include computing devices, virtual machines, integrated development environments (IDEs), libraries, applications, etc., that allow users (e.g., engineers, coders, data scientists, etc.) to create, code, develop, generate, train, etc., various perception models (e.g., to create neural networks). In other embodiments, the training data module 111 may be separate from a data science system. For example, the training data module 111 may be a separate set of computing devices and/or computing resources that are used to generate training data.

The training data module 111 may allow users to generate training data and train machine learning models using training or test data. For example, the training data module 111 may allow users to execute machine learning model 230 (e.g., a perception model, a neural network, etc.) using, candidate training data, validation data 240, etc. The candidate training data may be automatically generated by the training data module 111 (e.g., by a GAN, VAE, etc.). By generating varied types of training data, the machine learning model 230 may be trained to generalize better in different scenarios, conditions, situations, circumstances, and/or environments.

In one embodiment, the training data module 111 may generate a set of candidate training data based on the training data generator 210. For example, the training data generator 210 may be a generative adversarial network (GAN) and the training data module 111 may use the GAN to generate candidate training data (e.g., one or more images). In another example, the training data generate may be a variational autoencoder (VAE) and the training data module 111 may use the VAE to generate candidate training data. Although the present disclosure may refer to GANs or VAEs, other types of machine learning models may be used to generate candidate training data in other embodiments.

In one embodiment, the training data generator 210 may label, tag, annotate, the candidate training data that is generated. For example, the training data generator 210 may generate an image (e.g., candidate training data) and may include one or more tags that indicate what objects are in the image, what environments are depicted, etc. The labels may also be referred to as properties of the candidate training data.

In one embodiment, the candidate training data generated by the training data generator 210 (e.g., a GAN) may be referred as synthetic data or synthetic training data. Synthetic data or synthetic training data may be data that is generated by a machine learning models and/or that does not originate from a sensor (e.g., was not captured by a sensor, such as a camera).

In one embodiment, the training data module 111 may train the machine learning model 230 based on the set of candidate training data (that was generated by the training data generator 210). For example, the weights of the machine learning model 230 (e.g., a neural network) may be set based on how the machine learning model 230 processes the set of candidate training data. The machine learning model 230 may generate a set of inferences (e.g., one or more outputs, decisions, classifications, etc.) based on the set of candidate training data.

In one embodiment, the training data module 111 may determine a set of importance factors 250 based on the set of inferences (generated by the machine learning model 230 when the machine learning model 230 processed/analyzed the set of candidate training data) and the importance model 220. For example, training data module 111 may provide the set of inferences to the importance model 220 and the importance model 220 may analyze the machine learning model 230 as the machine learning model 230 is trained using the set of candidate training data. The importance model 220 may identify, determine, select, etc., factors of the candidate training data that were important during training.

In one embodiment, the importance model 220 may use an importance function (e.g., a calculation, an equation, a formula, etc.) to determine (e.g., to select or identify) the importance factors 250. The importance function may be defined by the following equation (1).

$${P}_{val} ( Y \vert X , ρ ) ∼ \int {dwP}_{0} ( w ) {P}_{val} ( Y \vert X , w ) {\prod }_{n = 1}^{N} \frac{{P ( {Y}_{n} \vert {X}_{n} , w )}^{{ρ}_{n}}}{{\sum }_{Y ′} {P ( Y ′ \vert {X}_{n} , w )}^{{ρ}_{n}}} \qquad ( 1 )$$

The prediction probability Pᵥₐₗ(Y|X, ρ) on the is defined by an integral over model weights w on the right. The terms under the integral are P₀(w) and Pᵥₐₗ(Y|X,w). P₀(w) may be the prior distribution of weights w. Pᵥₐₗ(Y|X,w) may be the model prediction probability conditional on weights w.

$${\prod }_{n = 1}^{N} \frac{{P ( {Y}_{n} \vert {X}_{n} , w )}^{{ρ}_{n}}}{{\sum }_{Y ′} {P ( Y ′ \vert {X}_{n} , w )}^{{ρ}_{n}}}$$

may be a product of prediction probabilities of training data samples for n=1 . . . N geometrically weighted by importance factors ρₙ.

In one embodiment, the training data module 111 may update the training data generator 210 based on one or more distributions of properties (e.g., property distributions). For example, the training data module 111 may update one or more weights, parameters, etc., of the training data generator 210 to cause the training data generator 210 to generate different candidate training data (e.g., images with different properties or labels). The one or more distributions of properties may include a first distribution of properties determined (e.g., calculated, determined, generated, etc.) based on the validation data 240. The one or more distributions of properties may also include a second distribution of properties determined (e.g., calculated, determined, generated, etc.) based on the set of candidate training data. The distribution module 260 may determine (e.g., calculate, generate, etc.) these distributions of properties based on the importance factors 250 determined by the importance model 220. For example, based on the importance factors 250 determined by the importance model 220, the training data module 111 may identify the portion of the candidate data (e.g., a subset of images) that was important in training the machine learning model 230. The portion of the candidate data that was important in training the machine learning model 230 may be data that has a certain amount of effect on the setting of the weights in the machine learning model 230.

In one embodiment, the distributions of properties may be associated with labels (e.g., tags, annotations, etc.) for the validation data 240 and/or for the set of candidate training data. For example, a distribution of properties (e.g., a property distribution) may indicate how many times images with particular labels were in the validation data 240. The particular labels in a distribution may be identified based on the importance factors 250 generated by the importance model 220. For example, the importance factors 250 may identify or indicate which labels and/or images had at least a threshold effect in training the machine learning model 230.

In one embodiment, the training data module 111 may determine whether the first distribution of properties for the set of candidate training data is within a threshold of the second distribution of properties for the set of validation data. For example, the training data module 111 may compare the difference between the values/points in the first distribution of properties and the second distribution of properties, as discussed in more detail below. The training data module 111 may determine whether the values/points in the first distribution of properties and the second distribution of properties are within a threshold difference of each other.

If the first distribution of properties for the set of candidate training data is not within a threshold of the second distribution of properties for the set of validation data, this may indicate that the training data generator 210 is not able to generate training data that sufficiently matches the properties of the validation data 240 (e.g., a desired distribution of properties). In one embodiment, the training data module 111 may update the training data generator 210 if the first distribution of properties for the set of candidate training data is not within a threshold of the second distribution of properties for the set of validation data. For example, the training data module 111 may update weights and/or parameters of the training data generator 210 (e.g., of a GAN).

In one embodiment, after the training data generator 210 is updated, the training data generator 210 may repeat the operations, actions, functions, etc., described above. For example, the training data module 111 may cause new candidate training data to be generated (by the training data generator 210), may retrain the machine learning model 230, may cause new importance factors to be determined (by the importance model 220), may cause new distributions of properties to be determined, etc.

In one embodiment, the training data generator 210 may be used to generate training data (for other machine learning models) if the first distribution of properties for the set of candidate training data is within a threshold of the second distribution of properties for the set of validation data. When the first distribution of properties for the set of candidate training data is within a threshold of the second distribution of properties for the set of validation data, this may indicate that the training data generator 210 is able to generate training data that sufficiently matches the properties of the validation data 240 (e.g., a desired distribution of properties). Thus, the training data generator 210 is ready to be used to generate training data that will be used to train machine learning models.

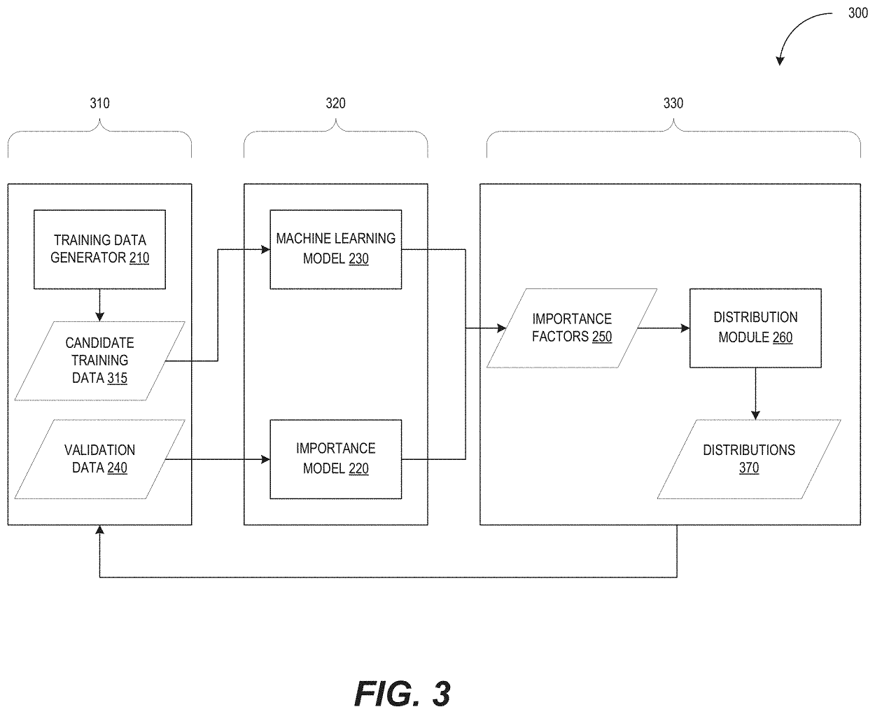

FIG. 3 is a block diagram that illustrates an example process 300 for training, tuning, etc., a training data generator (such as training data generator 210 illustrated in FIG. 2), in accordance with one or more embodiments of the present disclosure. The process 300 may be referred to as a cycle, loop, etc. The process 300 may be performed by the various modules, engines, components, and/or systems of the training data module 111 (illustrated in FIGS. 1 and 2). The process 300 includes three stages (e.g., phases, parts, portions, etc.), stage 310, stage 320, and stage 330. The process 300 may proceed from stage 310, to stage 320, to stage 330, and back to stage 310. Each iteration of the process 300 may generate a set of candidate training data (e.g., training data that will be evaluated, tested, etc., to determine if the training data should be added to a library of training data). The process 300 may iterate through the stages 310 through 330 until one or more conditions are satisfied (e.g., until the distribution of properties for the candidate training data is within a threshold of the distribution of properties for validation data).

At stage 310, the training data module 111 may generate a set of candidate training data 315 based on the training data generator 210. For example, the training data generator 210 may generate images and labels (e.g., tags, annotations, etc.) for the images. As discussed above, the candidate training data (or training data) generated by the training data generator 210 may be referred as synthetic data or synthetic training data. Also at stage 310, the validation data set 240 may also be obtained (e.g., the validation data set 240 may be accessed from a storage device, received from another computing device, or identified/selected by a user).

At stage 320, the machine learning model 230 is trained using the set of candidate training data (that was generated by the training data generator 210). For example, the weights of the machine learning model 230 (e.g., a neural network) may be set based on how the machine learning model 230 processes the set of candidate training data. Also at stage 320, the importance model 220 may determine a set of importance factors 250 based on the set of inferences (generated by the machine learning model 230 when the machine learning model 230 processed/analyzed the set of candidate training data) and the importance model 220. The importance model 220 may also use the validation data 240 to determine the set of importance factors 250.

At stage 330, the distribution module 260 may determine (e.g., generate, calculate, etc.) distributions 370 (e.g., distributions of properties, property distributions, etc.) for the candidate training data 315 and for a set of validation data (e.g., reference data). The distribution module 260 may compare the distributions 370 to determine if a first distribution of properties for the candidate training data is within a threshold of a second distribution of properties for the validation data whether the first distribution of properties for the set of candidate training data is within a threshold of the second distribution of properties for the set of validation data.

If the first distribution of properties for the set of candidate training data is not within a threshold of the second distribution of properties for the set of validation data, the training data generator 210 may be updated at stage 310. For example, the weights or parameters of the training data generator 210 may be changed, modified, tuned, etc. If the first distribution of properties for the set of candidate training data is within a threshold of the second distribution of properties for the set of validation data, the process 300 may end and the training data generator 210 may be used to generate training data for other machine learning models, such as other perception models or prediction/planning models.

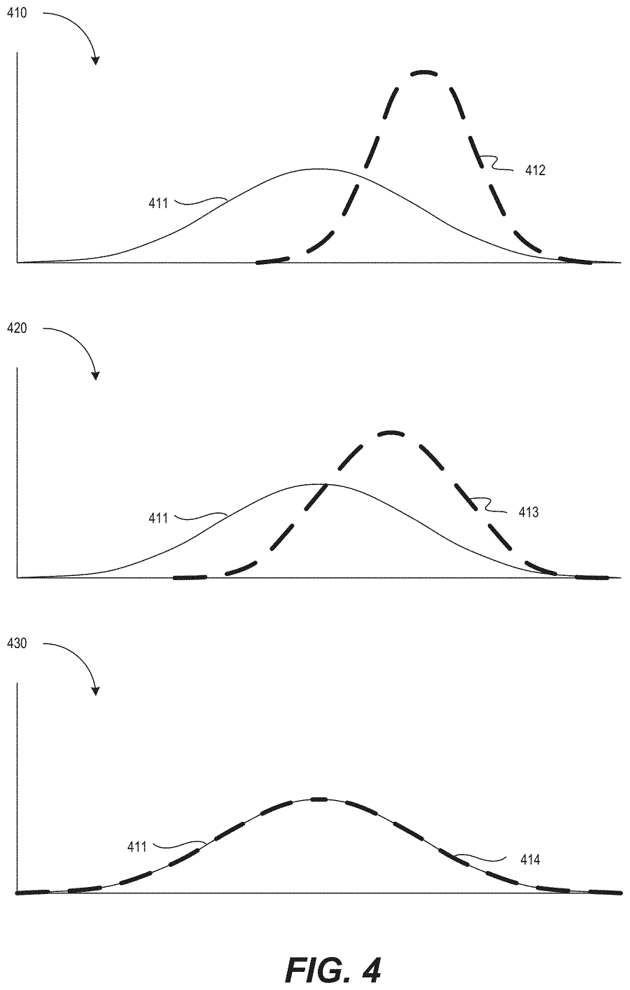

FIG. 4 is a diagram illustrating example graphs 410, 420, and 430, in accordance with one or more embodiments of the present disclosure. Graphs 410, 420, and 430 include distributions 411, 412, 413, and 414. As discussed above, the distributions may be distributions of properties or property distributions. A distribution may indicate how many times a property (e.g., a label, a feature, etc.) occurs in a set of data, as discussed above. In one embodiment, distribution 411 may be based on a set of validation data (e.g., a set of reference data).

Graph 410 includes distributions 411 and 412. Distribution 412 may be based on a set of candidate training data generated by the training data generator. As illustrated in FIG. 4, distribution 412 is not within a threshold of distribution 411. For example, there are points within distribution 412 that are greater than a threshold distance from points on distribution 411. In another example, the shape and location of distribution 412 is not within a threshold shape or location of distribution 411. Because distribution 412 is not within a threshold of distribution 411, the training data generator may be updated and a new set of candidate training data may be generated.

Graph 420 includes distributions 411 and 413. Distribution 413 may be based on a later set of candidate training data generated by the training data generator. As illustrated in FIG. 4, distribution 413 is also not within a threshold of distribution 411. Because distribution 413 is not within a threshold of distribution 411, the training data generator may be updated and a new set of candidate training data may be generated.

Graph 430 includes distributions 411 and 414. Distribution 414 may be based on a final set of candidate training data generated by the training data generator. As illustrated in FIG. 4, distribution 414 is within a threshold of distribution 411. Because distribution 414 is within a threshold of distribution 411, the training data generator may be finalized (e.g., the weights and parameters of the training data generator may be finalized) and the training data generator may be used to generate training data for other machine learning models.

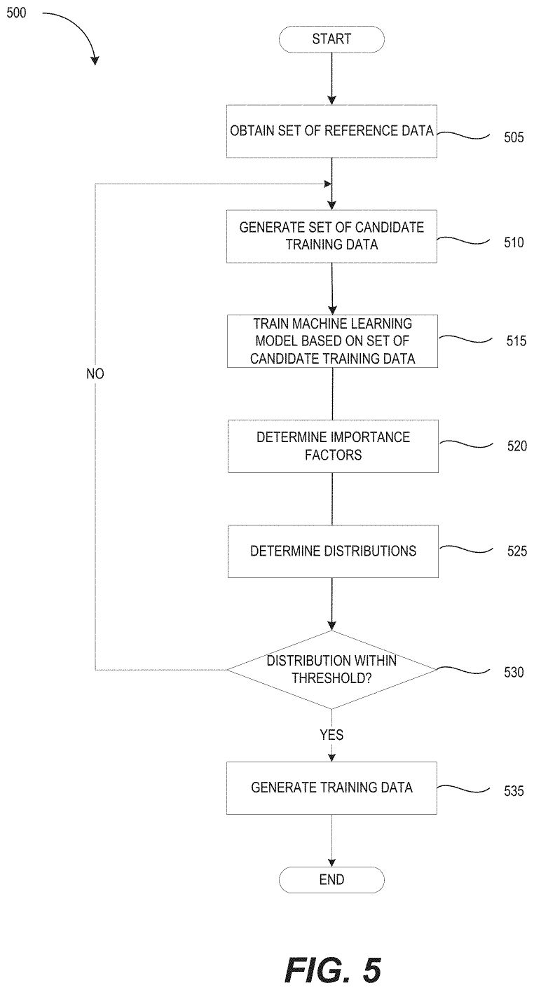

FIG. 5 is a flow diagram of a process 500 for generating training data (e.g., synthetic data or synthetic training data), in accordance with one or more embodiments of the present disclosure. Process 500 may be performed by processing logic that may comprise hardware (e.g., circuitry, dedicated logic, programmable logic, a field programmable gate array (FPGA), an application specific integrated circuit (ASIC), a processor, a processing device, a central processing unit (CPU), a system-on-chip (SoC), etc.), software (e.g., instructions running/executing on a processing device), firmware (e.g., microcode), or a combination thereof. In some embodiments, the process 500 may be performed by a computing device (e.g., a server computer, a desktop computer, etc.), a data science system (e.g., data science system 110 illustrated in FIG. 1), a training data module (e.g., training data module 111 illustrated in FIGS. 1-3), and/or various components, modules, engines, systems, etc., of a training data module (as illustrated in FIGS. 1-3).

The process 500 begins at block 505 where the process 500 obtains a set of reference data. For example, the process 500 may receive a set of validation data or may access the set of validation data from a data storage device. At block 510, the process 500 may generate a set of candidate training data based on a training data generator. For example, the process 500 may use a GAN, a VAE, etc., to generate the set of candidate training data. At block 515, the process 500 may train a machine learning model based on (e.g., using) the set of candidate training data. At block 520, the process 500 may determine a set of importance factors. For example, the process 500 may analyze the machine learning model and/or the inferences generated by the machine learning model, as the machine learning model was trained using the candidate training data.

At block 525, the process 500 may determine (e.g., generate, calculate, etc.) a first distribution of properties (e.g., for the reference data) and a second distribution of properties (for the candidate training data). The process 500 may compare the two distributions of properties and may determine whether the second distribution of properties is within a threshold of the first distribution of properties. If the second distribution of properties is not within a threshold of the first distribution of properties, the process 500 may proceed to block 510. If the second distribution of properties is within a threshold of the first distribution of properties, the process 500 may optionally generate training data based on the training data generator. The process 500 may also finalize the training data generator (e.g., finalize the weights, parameters, etc.) of the training data generator.

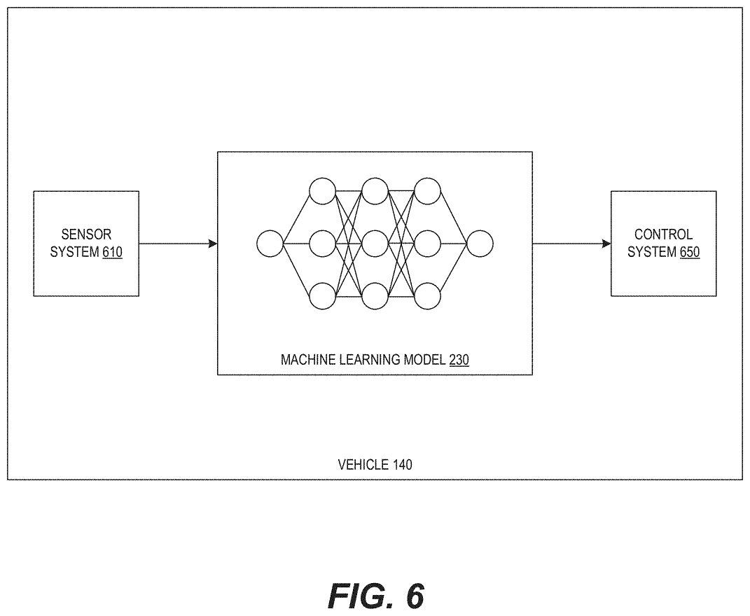

FIG. 6 is a block diagram that illustrates an example vehicle 140, in accordance with one or more embodiments of the present disclosure. In one embodiment, the vehicle 140 may be an autonomous vehicle (e.g., a self-driving vehicle). For example, the vehicle 140 may be a vehicle (e.g., car, truck, van, mini-van, semi-truck, taxi, drone, etc.) that may be capable of operating autonomously. In another embodiment, the vehicle 140 may also be a vehicle with autonomous capabilities. A vehicle 140 vehicle with autonomous capabilities may be a vehicle that may be capable of performing some operations, actions, functions, etc., autonomously. For example, vehicle 140 may have adaptive cruise control capabilities and/or lane assist/keep capabilities. A vehicle 140 with autonomous capabilities may be referred to as a semi-autonomous vehicle. The vehicle 140 may include various systems that allow the vehicle 140 to operate autonomously and/or semi-autonomously. For example, vehicle 140 includes a sensor system 610, a control system 650, and machine learning model 230.

The sensor system 610 may include one or more sensors (e.g., detectors, sensing elements, sensor devices, etc.). The one or more sensors may provide information about the operation of the vehicle 140, information about the condition of the vehicle 140, information about occupants/users of the vehicle 140, and/or information about the environment (e.g., a geographical area) where the vehicle 140 is located. The one or more sensors may be coupled to various types of communication interfaces (e.g., wired interfaces, wireless interfaces, etc.) to provide sensor data to other systems of the vehicle 140. For example, a sensor may be coupled to a storage device (e.g., a memory, a cache, a buffer, a disk drive, flash memory, etc.) and/or a computing device (e.g., a processor, an ASIC, an FPGA, etc.) via a control area network (CAN) bus. In another example, a sensor may be coupled to a storage drive and/or a computing device via Bluetooth, Wi-Fi, etc. Examples of sensors may include a camera, a radar sensor, a LIDAR sensor, etc.

The control system 650 may include hardware, software, firmware, or a combination thereof that may control the functions, operations, actions, etc., of the vehicle 140. For example, the control system 650 may be able to control a braking system and/or an engine to control the speed and/or acceleration of the vehicle 140. In another example, the control system 650 may be able to control a steering system to turn the vehicle 140 left or right. In a further example, the control system 650 may be able to control the headlights or an all-wheel drive (AWD) system of the vehicle 140 based on weather/driving conditions (e.g., if the environment has snow/rain, if it is night time in the environment, etc.). The control system 650 may use sensor data and/or outputs generated by machine learning models to control the vehicle 140.

The control system 650 may use outputs generated by machine learning model 230 to control the vehicle. For example, control system 650 may generate one or more steering commands based on the outputs of the machine learning model 230 (e.g., based on objects detected by the machine learning model 230). The steering command may indicate the direction that a vehicle 140 should be turned (e.g., left, right, etc.) and may indicate the angle of the turn. The control system 650 may actuate one or more mechanisms/systems (e.g., a steering system, a steering wheel, etc.) to turn the vehicle 140 (e.g., to control the vehicle 140) based on the steering command. For example, the control system 650 may turn the steering wheel by a certain number of degrees to steer the vehicle 140. The control system 650 may also control acceleration and/or deceleration of the vehicle 140. For example, the control system 650 may use the accelerator to speed up the vehicle 140 or may use the brake to slow down the vehicle 140.

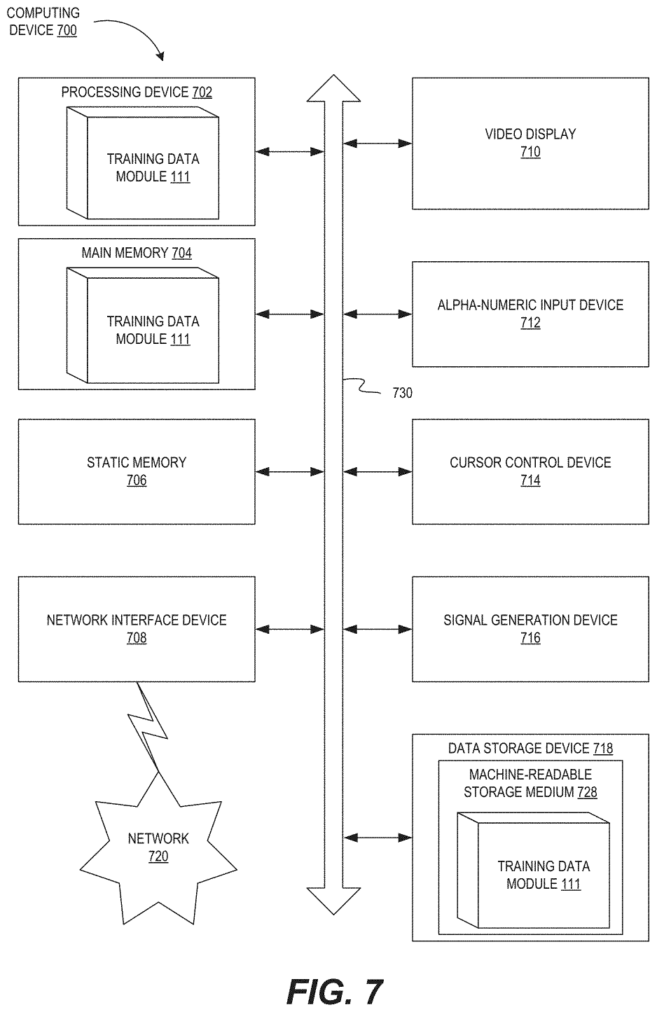

FIG. 7 is a block diagram of an example computing device 700 that may perform one or more of the operations described herein, in accordance with some embodiments. Computing device 700 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 700 may include a processing device (e.g., a general purpose processor, a PLD, etc.) 702, a main memory 704 (e.g., synchronous dynamic random access memory (DRAM), read-only memory (ROM)), a static memory 706 (e.g., flash memory and a data storage device 718), which may communicate with each other via a bus 730.

Processing device 702 may be provided by one or more general-purpose processing devices such as a microprocessor, central processing unit, or the like. In an illustrative example, processing device 702 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 702 may also comprise one or more special-purpose processing devices such as an application specific integrated circuit (ASIC), a field programmable gate array (FPGA), a digital signal processor (DSP), network processor, or the like. The processing device 702 may be configured to execute the operations described herein, in accordance with one or more aspects of the present disclosure, for performing the operations and steps discussed herein.

Computing device 700 may further include a network interface device 708 which may communicate with a network 720. The computing device 700 also may include a video display unit 710 (e.g., a liquid crystal display (LCD) or a cathode ray tube (CRT)), an alphanumeric input device 712 (e.g., a keyboard), a cursor control device 714 (e.g., a mouse) and an acoustic signal generation device 716 (e.g., a speaker). In one embodiment, video display unit 710, alphanumeric input device 712, and cursor control device 714 may be combined into a single component or device (e.g., an LCD touch screen).

Data storage device 718 may include a computer-readable storage medium 728 on which may be stored one or more sets of instructions, e.g., instructions for carrying out the operations described herein, in accordance with one or more aspects of the present disclosure. Instructions implementing the different systems described herein (e.g., the training data module 111 and/or various components, modules, engines, systems, etc., of a training data module (as illustrated in FIGS. 1-3) may also reside, completely or at least partially, within main memory 704 and/or within processing device 702 during execution thereof by computing device 700, main memory 704 and processing device 702 also constituting computer-readable media. The instructions may further be transmitted or received over a network 720 via network interface device 708.

While computer-readable storage medium 728 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “generating,” “determining,” “training,” “driving,” “obtaining,” “tagging,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method, comprising:
generating a set of candidate training data based on a training data generator;
training a first machine learning model based on the set of candidate training data, wherein the first machine learning model generates a set of inferences during the training based on the set of candidate training data;
determining a set of importance factors based on the set of inferences and a second machine learning model; and
updating the training data generator based on one or more distributions of properties determined based on the set of importance factors.

2. The method of claim 1, wherein:
the set of importance factors is determined by the second machine learning model; and
the second machine learning model uses an importance function to determine the set of importance factors based on the set of inferences and the set of reference data.

3. The method of claim 1, wherein the set of reference data set comprises a set of validation data.

4. The method of claim 1, further comprising:
determining a first distribution of properties for the set of candidate training data and a second distribution of properties for the set of reference data.

5. The method of claim 4, further comprising:
determining whether the first distribution of properties for the set of candidate training data is within a threshold of the second distribution of properties for the set of validation data.

6. The method of claim 5, wherein the training data generator is updated in response to determining that the first distribution of properties for the set of candidate training data is not within a threshold of the second distribution of properties for the set of validation data.

7. The method of claim 5, further comprising:
in response to determining that the first distribution of properties for the set of candidate training data is not within a threshold of the second distribution of properties for the set of validation data:
generating a second set of candidate training data based on a training data generator;
training the first machine learning model based on the second set of candidate training data, wherein the first machine learning model generates a second set of inferences during the training based on the second set of candidate training data; and
determining a second set of importance factors based on the second set of inferences and the second machine learning model.

8. The method of claim 5, further comprising:
in response to determining that the first distribution of properties for the set of candidate training data is within a threshold of the second distribution of properties for the set of validation data, generating training data based on the training data generator, wherein the training data is provided to other machine learning models to train the other machine learning models.

9. The method of claim 5, wherein the first distribution of properties and the second distribution of properties are associated with labels for the set of validation data.

10. The method of claim 1, wherein the training data generator comprises one or more of a generative adversarial network or a variational autoencoder.

11. The method of claim 1, wherein the set of training data comprises synthetic training data.

12. An apparatus, comprising:
a memory configured to store data; and
a processing device coupled to the memory, the processing device configured to:
generate a set of candidate training data based on a training data generator;
train a first machine learning model based on the set of candidate training data, wherein the first machine learning model generates a set of inferences during the training based on the set of candidate training data;
determine a set of importance factors based on the set of inferences and a second machine learning model; and
update the training data generator based on one or more distributions of properties determined based on the set of importance factors.

13. The apparatus of claim 12, wherein:
the set of importance factors is determined by the second machine learning model; and
the second machine learning model uses an importance function to determine the set of importance factors based on the set of inferences and the set of reference data.

14. The apparatus of claim 12, wherein the set of reference data set comprises a set of validation data.

15. The apparatus of claim 12, wherein the processing device is further to:
determine a first distribution of properties for the set of candidate training and a second distribution of properties for the set of reference data.

16. The apparatus of claim 15, wherein the processing device is further to:
determine whether the first distribution of properties for the set of candidate training data is within a threshold of the second distribution of properties for the set of validation data.

17. The apparatus of claim 15, wherein the training data generator is updated in response to determining that the first distribution of properties for the set of candidate training data is not within a threshold of the second distribution of properties for the set of validation data.

18. The apparatus of claim 15, wherein the processing device is further to:
in response to determining that the first distribution of properties for the set of candidate training data is not within a threshold of the second distribution of properties for the set of validation data:
generate a second set of candidate training data based on a training data generator;
train the first machine learning model based on the second set of candidate training data, wherein the first machine learning model generates a second set of inferences during the training based on the second set of candidate training data; and
determine a second set of importance factors based on the second set of inferences and the second machine learning model.

19. The apparatus of claim 15, wherein the processing device is further to:
in response to determining that the first distribution of properties for the set of candidate training data is within a threshold of the second distribution of properties for the set of validation data, generate training data based on the training data generator, wherein the training data is provided to other machine learning models to train the other machine learning models.

20. A non-transitory computer-readable storage medium including instructions that, when executed by a processing device, cause the processing device to perform operations comprising:
generating a set of candidate training data based on a training data generator;
training a first machine learning model based on the set of candidate training data, wherein the first machine learning model generates a set of inferences during the training based on the set of candidate training data;
determining a set of importance factors based on the set of inferences and a second machine learning model; and
updating the training data generator based on one or more distributions of properties determined based on the set of importance factors.
